(19) United States
(12) Patent Application Publication
(10) Pub. No.: US 2025/0245662 A1
(43) Pub. Date: Jul. 31, 2025

(54) METHOD AND SYSTEM FOR BLOCKCHAIN-ENABLED VASP CATEGORIZATION AND TAXATION SYSTEM

(71) Applicant: Mastercard International Incorporated, Purchase, NY (US)

(72) Inventors: Jaipal Singh KUMAWAT, Sikar (IN); Avinash Upadhyay, Noida (IN)

(73) Assignee: Mastercard International Incorporated, Purchase, NY (US)

(21) Appl. No.: 18/428,040

(22) Filed: Jan. 31, 2024

(51) Int. Cl. G06Q 20/40; G06Q 20/38

(52) U.S. Cl. CPC G06Q 20/4014; G06Q 20/3825; G06Q 20/3829; G06Q 20/389

(57) ABSTRACT

A method for categorization of virtual asset service providers (VASPs) via transaction analysis and blockchain includes: storing an account profile associated with a VASP including a first industry classification and entity identifier for the VASP; receiving transaction data for a plurality of payment transactions involving the VASP; analyzing the received transaction data to identify a second industry classification associated with the VASP different from the first industry classification; and transmitting the second industry classification and entity identifier associated with the VASP to a blockchain node in a blockchain network for addition to a blockchain.

### FIELD

The present disclosure relates to the categorization of virtual asset service providers (VASPs) through use of a blockchain, specifically the analysis of transaction activity of VASP to categorize the classification of a VASP for use with taxation and other services.

### BACKGROUND

Virtual Asset Service Providers (VASPs) are entities that operate in the cryptocurrency and blockchain industries that can provide a variety of services to blockchain participants. Such entities can include cryptographic currency exchanges, blockchain wallet providers, token issuers, etc. Because of the complexities involved in blockchains and the wide variety of applicability of blockchain technology for different types of transactions and transfers, it can be difficult to classify entities involved in a blockchain, such as VASPs, for taxation and regulatory purposes.

In traditional financial systems, merchant category codes (MCCs) are used as a way to categorize businesses based on the services they provide, which are often used when applying regulations and tax rates to businesses. However, there is no equivalent to an MCC as related to blockchain. This lack of standardized industry classification for VASPs presents a difficult challenge for taxation and regulatory agencies to properly assess and monitor entities that could be engaging in nefarious behavior. Thus, there is a need for a technological solution to enable the industry classification of entities involved in transactions on blockchains.

### SUMMARY

The present disclosure provides a description of systems and methods for categorization of virtual asset service providers (VASPs) via transaction analysis and blockchain. A processing server can maintain an account profile for a VASP that includes a current classification and identifier for the VASP, such as based on data provided by the VASP during a registration process. The processing server can receive transaction data for new payment transactions that involve the VASP, such as new cryptographic currency transactions added to a blockchain. The processing server can analyze the new payment transactions to determine that the industry classification has changed for the VASP, such as based on the amounts, participants, and frequency of the transactions, which can be compared to transaction activity of other entities with known industry classifications. The new classification is assigned to the VASP and stored in a publicly accessible blockchain, where authorities and applicable agencies can use the new classification, such as for the application of tax rates and rules and industry regulations. The result is a standard and transparent process for the industry classification of VASPs.

A method for categorization of virtual asset service providers (VASPs) via transaction analysis and blockchain includes: storing, in an account database of a processing server, an account profile associated with a VASP, wherein the account profile includes at least a first industry classification and entity identifier associated with the VASP; receiving, by a receiver of the processing server, transaction data for a plurality of payment transactions involving the VASP, the transaction data for each payment transaction of the plurality of payment transactions including at least the entity identifier; analyzing, by a processor of the processing server, at least the received transaction data to identify a second industry classification associated with the VASP, wherein the second industry classification is different than the first industry classification; and transmitting, by a transmitter of the processing server, at least the second industry classification and the entity identifier associated with the VASP to a blockchain node in a blockchain network for addition to a blockchain associated with the blockchain network.

A system for categorization of virtual asset service providers (VASPs) via transaction analysis and blockchain includes: a blockchain network; a blockchain node in the blockchain network; and a processing server, the processing server including an account database storing an account profile associated with a VASP, wherein the account profile includes at least a first industry classification and entity identifier associated with the VASP, a receiver receiving transaction data for a plurality of payment transactions involving the VASP, the transaction data for each payment transaction of the plurality of payment transactions including at least the entity identifier, a processor analyzing at least the received transaction data to identify a second industry classification associated with the VASP, wherein the second industry classification is different than the first industry classification, and a transmitter transmitting at least the second industry classification and the entity identifier associated with the VASP to the blockchain node for addition to a blockchain associated with the blockchain network.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for categorization of virtual asset service providers in accordance with exemplary embodiments.

FIG. 2 is a block diagram illustrating the processing server in the system of FIG. 1 for categorization of virtual asset service providers in accordance with exemplary embodiments.

FIG. 3 is a flow diagram illustrating a process for categorization of virtual asset service providers by the processing server in the system of FIG. 1 in accordance with exemplary embodiments.

FIG. 4 is a flow chart illustrating an exemplary method for categorization of virtual asset service providers in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Categorization of Virtual Asset Service Providers

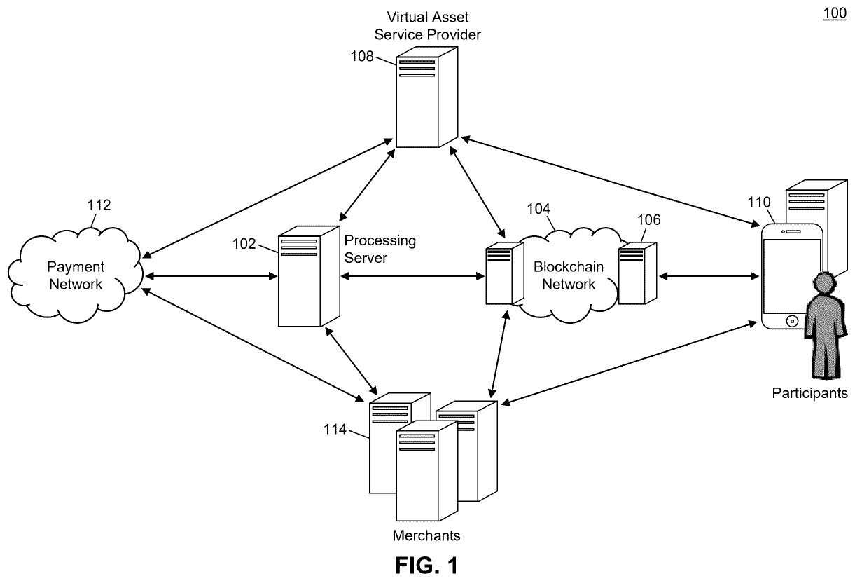

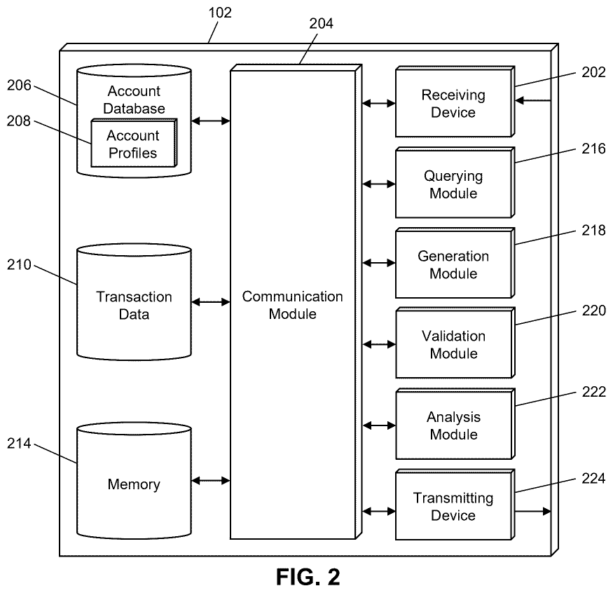

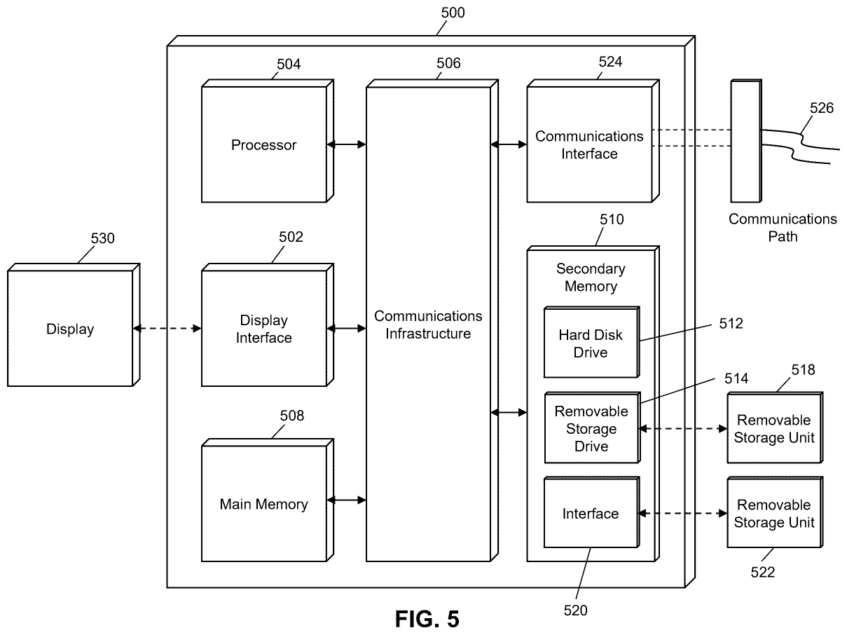

FIG. 1 illustrates a system 100 for the categorization of virtual asset service providers (VASPs) via transaction analysis and blockchain. The system 100 can include a processing server 102. The processing server 102, discussed in more detail below, can be a computing system, such as illustrated in FIG. 2 or 5, discussed in more detail below, configured to analyze transaction data and other available data to categorize VASPs and other entities involved in cryptographic currency and other transactions on one or more blockchains.

Blockchains can be operated by blockchain networks 104, where each blockchain can be operated by a separate blockchain network 104 and/or where a blockchain network 104 can operate multiple blockchains. A blockchain network 104 can be comprised of a plurality of blockchain nodes 106. Each blockchain node 106 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In exemplary embodiments, the processing server 102 can be a blockchain node 106 in the blockchain networks 104.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, the processing server 102 can be configured to determine an industry classification for a VASP 108 as a way of categorizing VASPs, such as for use in taxation and regulatory purposes. As used herein, VASP 108 can refer to the service provider as an entity itself or one or more computing systems of the service provider for performing the functions discussed herein associated with the service provider. A VASP 108 can participate in one or more blockchains by being involved in cryptographic currency, also referred to as cryptocurrency, transactions or other transactions that are stored in the blockchain, such as where value is transferred to or from the VASP, or other activity related to the blockchain, such as by operating blockchain wallets on behalf of participants 110 to a blockchain. As discussed herein, participants 110 can refer to individuals, entities, or devices that are involved in payment transactions, including blockchain transactions as well as traditional payment transactions that can use fiat currency.

In the system 100, a VASP 108 can be required to register with the processing server 102, such as can be required by a governmental agency or regulatory authority that has jurisdiction over where the VASP 108 operates or can be required by the blockchain network 104 for which the VASP 108 is a participant. As part of the registration, the VASP 108 can provide the processing server 102 with information regarding the VASP 108, such as a company name, business address, geographic location, offered services, contract information, etc. In some embodiments, registration can include the registration of one or more devices of the VASP 108. For example, as part of the registration information, the VASP 108 can provide device identification data such as, a unique device identifier number (UDID), a Google advertising identification (GAID), an international mobile equipment identity (IMEI) code, a media access control (MAC) address, or a secure identification code, etc. The processing server 102 can store the information in an account profile associated with the VASP 108. Further, in some embodiments, the VASP 108 can generate a unique registration code, e.g., a password, or the processing server 108 may generate a unique verification code for verification of the VASP 108 to verify the identity of the VASP 108 for access to the account profile associated with the VASP 108. The VASP 108 can be assigned an initial industry classification by the processing server 102 based on the supplied registration information. In some cases, the VASP 108 can provide its initial industry classification. Industry classifications can be merchant category codes (MCCs) or other values that can be recognized and used by applicable entities for taxation, regulatory, and other purposes. In some cases, the processing server 102 can identify multiple types of industry classifications for each VASP 108, such as a MCC and an additional industry classification.

When the industry classification for a VASP 108 is determined, the processing server 102 can submit the industry classification and a unique identifier associated with the VASP 108 to a blockchain node 106. The unique identifier can be any value that is unique to the VASP 108 and used for identification thereof, which can be generated or otherwise assigned by the processing server 102 during the registration process. The blockchain node 106 can receive the industry classification and the unique identifier and generate a new blockchain data entry that includes the industry classification and unique identifier. The new blockchain data entry can be added to a new block that is validated, confirmed, and added to a blockchain using traditional systems and methods. The blockchain used to store the industry classification can be a public blockchain that is used exclusively to store industry classification data for VASPs, which can be accessed by applicable agencies and authorities, such as when determining applicability of industry regulations to a VASP 108. In some cases, a blockchain data entry can be added to the blockchain for each registered VASP 108 that includes their unique identifier and business information that can be used by an entity to identify the VASP 108. In other cases, the processing server 102 can provide the unique identifiers for registered VASPs to interested entities for use in identifying blockchain data entries related to a specific VASP 108.

After an initial industry classification for a VASP 108 has been determined and added to the blockchain, the processing server 102 can monitor for future activity involving the VASP 108 for use in updating the industry classification for the VASP 108 to ensure that the industry classification stored on the blockchain is always up to date and accurate for the VASP 108. Activity monitored by the processing server 102 can include blockchain transaction activity for blockchain transactions that involve the VASP 108 stored on one or more blockchains. The processing server 102 can receive blockchain data entries from blockchain nodes 106 in blockchain networks 104 and, using data included therein to identify any blockchain transaction that involves a registered VASP 108, such as based on data included in a VASP's account profile, such as public keys of blockchain wallets, identification values, etc. The processing server 102 can analyze the transaction data for the new blockchain transactions involving the VASP 108 to determine if the industry classification for the VASP 108 has changed. If the industry classification has not changed, then no additional actions can be performed and the processing server 102 can continue to monitor for new data for use in maintaining the accurate industry classification of the VASP 108. If the industry classification has changed, then the processing server 102 can submit the new industry classification and the unique identifier for the VASP 108 to a blockchain node 106 in the blockchain network 104, which can add the new industry classification into a new blockchain data entry stored on the blockchain, keeping the accurate industry classification for the VASP 108 up to date and publicly accessible.

In some cases, the processing server 102 can use more than transaction data for blockchain transactions involving the VASP 108 when determining the industry classification for a VASP 108. In some cases, the processing server 102 can use transaction data for other blockchain transactions that do not involve the VASP 108, which can include blockchain transactions on blockchains for which the VASP 108 is a participant and other blockchains for which the VASP 108 is not a participant. Such transactions can involve other entities, which can be other VASPs or other types of entities or service providers, illustrated in FIG. 1 as merchants 114. The processing server 102 can compare the transaction activity of the VASP 108 with the activity of merchants 114 whose industry classifications are known as part of the analysis to determine the industry classification of the VASP 108.

In some embodiments, the processing server 102 can also utilize transaction data for traditional payment transactions that utilize fiat currency. In such embodiments, the processing server 102 can collect transaction data for traditional payment transactions from one or more payment networks 112. Payment networks 112 can be payment processors that are configured to process traditional payment transactions through payment rails or other suitable infrastructure for which fiat currency is transferred from one entity to another using a suitable type of payment instrument. Payment networks 112 can provide transaction data for a plurality of different payment transactions to the processing server 102, either directly or via one or more data collection agencies. Transaction data for traditional payment transactions can include transaction amounts, merchant identifiers, transaction times and/or dates, product data, MCCs, financial institution identifiers, and any other data, such as can be stored in a transaction message, such as those transaction messages formatted in compliance with the International Organization of Standardization's ISO 8583 or ISO 20022 standards.

In these embodiments, the processing server 102 can use the transaction data for traditional payment transactions as part of the analysis in determining the industry classification of a VASP 108. In some cases, the VASP 108 can be involved in traditional payment transactions. In such cases, the processing server 102 can identify the traditional payment transactions that involve the VASP 108, such as by using data included in its account profile and use the activity of those traditional payment transactions along with the blockchain transactions involving the VASP 108 to determine its industry classification. The processing server 102 can also compare the activity of the traditional payment transactions with the activity of other merchants 114 in traditional payment transactions as part of the analysis to determine the industry classification for the VASP 108. In some instances, a VASP 108 may not participate in traditional payment transactions. In such instances, the processing server 102 can still identify merchants 114 that have similar blockchain transaction activity with the blockchain transaction activity of the VASP 108 and can analyze traditional payment transaction activity of those similar merchants 114 when determining the industry classification for the VASP 108.

The processing server 102 can also be configured to utilize any other available data in determining the industry classification for the VASP 108. Such data can include other business practices and dealings for the VASP 108, other transactional or other behavior of participants 110 that are associated with the VASP 108 (e.g., transactions by participants 110 for whom the VASP 108 is a wallet provider), regulatory filings by the VASP 108, findings by regulatory entities or other agencies applicable to the VASP 108, etc. Such data can be identified by the processing server 102 from publicly accessible database, received from appropriate third-party data providers, or provided by the VASP 108 during registration or as part of ongoing supplying of data to ensure the accurate industry classification of the VASP 108.

The processing server 102 can be configured to perform the analysis to determine the industry classification of a VASP 108 at predetermined intervals. In some cases, the predetermined interval can be a period of time (e.g., daily, weekly, monthly, quarterly, etc.). In other cases, the predetermined interval can be based on the receipt of new data for analysis, such as when a predetermined number of new transactions has been received, which can be transactions involving the VASP 108 or all transactions. In some instances, the processing server 102 can perform analysis to determine the industry classification for a VASP 108 upon request, such as can be requested by the VASP 108 or a third-party, such as a tax service.

In some embodiments, the processing server 102 can provide an interface through which the VASP 108 can provide the additional data for use in future analysis by the processing server 102 for keeping the industry classification for the VASP 108 accurate. In some instances, the processing server 102 can notify the VASP 108 when a new industry classification for the VASP 108 has been determined, such as via the interface or other suitable communication method. In some such instances, the VASP 108 can be provided an opportunity to confirm or dispute the new industry classification, where the VASP 108 can provide additional data as part of the dispute, which can be used by the processing server 102 in additional analysis to determine the industry classification for the VASP 108.

In some embodiments, the processing server 102 can be configured to perform reporting, such as for tax services, governmental entities, regulatory agencies, etc. In such embodiments, the processing server 102 can generate reports that include industry classification information for one or more VASPs 108 that can be electronically transmitted to an entity using a suitable communication network and method. For example, the processing server 102 can receive a verification request from a requesting entity, such as a tax services, governmental entities, regulatory agencies, etc., to verify a current industry classification for a specific VASP. The processing server 102 can execute a query on the blockchain to identify blockchain data related to the specific VASP. The processing server 102 can generate an industry classification report including the currency industry classification of the specific VASP and transmit the industry classification report to the requesting entity. In some cases, the processing server 102 can generate periodic reports for all VASPs 108 for which an entity is interested, which can include the latest industry classification for each VASP 108, that is then transmitted to the entity. In other cases, the processing server 102 can report any time a new industry classification is determined for a VASP 108 to each entity that is interested in the industry classification for that VASP 108. In some cases, the processing server 102 can generate reports that can be made publicly accessible, such as via the blockchain or other suitable method.

The methods and systems discussed herein provide for the categorization of VASPs that are involved in blockchains. The ongoing use of blockchain transaction data as well as any other available data and analysis thereof ensures that the industry classification for a VASP is kept up to date based on their ongoing activity. By storing determined industry classifications in a public blockchain, the process for determining industry classifications is transparent and secure. Because blockchains are immutable and there are timestamps for all blockchain data entries, any interested governmental agency or other entity can easily identify the industry classification for any VASP or other entity that is accurate to a specific date and cannot be tampered with or fraudulently changed. The result is a secure, up-to-date system for the categorization of VASPs and other entities involved in blockchains.

### Processing Server

FIG. 2 illustrates an embodiment of the processing server 102 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102.

The processing server 102 can include a receiving device 202. The receiving device 202 can be configured to receive data over one or more networks via one or more network protocols. In some instances, the receiving device 202 can be configured to receive data from blockchain nodes 106, virtual asset service providers (VASPs) 108, payment networks 112, merchants 114, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 that can be superimposed or otherwise encoded with blockchain data entries, blocks, and other blockchain data. The receiving device 202 can be configured to receive data signals electronically transmitted by VASPs 108, which can be superimposed or otherwise encoded with registration data, ongoing data used for analysis, data requests, transaction data, participant data, etc. The receiving device 202 can also be configured to receive data electronically transmitted by payment networks 112 that can be superimposed or otherwise encoded with transaction messages or other transaction data for traditional payment transactions. The receiving device 202 can also be configured to receive data electronically transmitted by merchants 114, which can be superimposed or otherwise encoded with business data, transaction data, industry classification data, and other data that can be used in analysis for determining industry classifications for VASPs 108. The receiving device 202 can also be configured to receive data electronically transmitted by one or more regulatory entities, which can be superimposed or otherwise encoded with regulatory requests, verification requests, entity identifiers, and other data that can be used to verify an industry classification of the VASPs 108.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, analysis module 222, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an account database 206. The account database 206 can be configured to store one or more account profiles 208 using a suitable data storage format and schema. The account database 206 can be a relational database that utilizes structured query language for the storage, identification, modifying, updating, accessing, etc. of structured data sets stored therein. Each account profile 208 can be a structured data set configured to store data related to a VASP 108 or other entity for which industry classification is to be determined or for which data is collected for use in determining industry classifications. An account profile 208 can store, for example, business information, business name, business address, geographic location, device identification data, industry classification, merchant category code, transaction data, participant data, user behavior information, blockchain wallet data, unique identifier, unique registration code, etc. In embodiments, the account database 206 can be a blockchain and the one or more account profiles 208 and any data associated with the one or more account profiles 208 can be one or more data values stored on the blockchain.

The processing server 102 can also include transaction data 210, which can be stored in a memory 214 of the processing server 102 or stored in a separate area within the processing server 102 or accessible thereby. The transaction data 210 can include transaction messages, blockchain data entries, or any other type of data entry that can include data for a payment transaction including blockchain transactions involving cryptographic currency and traditional payment transactions involving fiat currency. Transaction data 210 for blockchain transactions can include transaction amounts, hash values, destination addresses, unspent transaction outputs, digital signatures, smart contract data, etc. Transaction data 210 for traditional payment transactions can include transaction amounts, merchant identifiers, transaction times and/or dates, product data, MCCs, financial institution identifiers, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys including public keys and/or private keys, communication data, blockchain algorithms and data, industry classification data and rules, regulations, taxation rules, analytical algorithms, etc.

The processing server 102 can include a querying module 216. The querying module 216 can be configured to execute queries on databases to identify information. The querying module 216 can receive one or more data values or query strings and can execute a query string based thereon on an indicated database, such as the account database 206 of the processing server 102 to identify information stored therein. The querying module 216 can then output the identified information to an appropriate engine or module of the processing server 102 as necessary. The querying module 216 can, for example, execute a query on the account database 206 to identify an account profile 208 for use of data included therein in analysis to determine the industry classification for a VASP 108. In embodiments where the account database 206 is a blockchain, the querying module 216 can, for example, execute a query on the blockchain to identify one or more data values associated with one or more entity identifiers for use of data included therein in analysis to determine the industry classification for a VASP 108.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate blockchain data entries, notification messages, data requests, industry classification reports, etc.

The processing server 102 can also include a validation module 220. The validation module 220 can be configured to perform data validations and verifications for the processing server 102 as part of the functions discussed herein. The validation module 220 can receive instructions as input, can perform data validations or verification as instructed, and can output a result of the data validations or verifications to one or more modules of the processing server 102. In some cases, the input can include the data to be validated or verified and/or data to be used in the validation or verification. In other cases, the validation module 220 can be configured to identify such data, such as in the account database 206 and/or memory 214. The validation module 220 can be configured to, for example, validate registration data, validate digital signatures for blockchain transactions, authenticate data received by the receiving device 202, etc.

The processing server 102 can also include an analysis module 222. The analysis module 222 can be configured to analyze data for the processing server 102 as part of the functions discussed herein. The analysis module 222 can receive instructions as input, can analyze data as instructed, and can output a result of the analysis to one or more modules of the processing server 102. In some cases, the input can include the data to be analyzed. In other cases, the analysis module 222 can be configured to identify such data, such as in the account database 206, transaction data 210, and memory 214. The analysis module 222 can be configured to analyze transaction data and all other available data to determine the industry classification for a VASP 108, as discussed above.

The processing server 102 can also include a transmitting device 224. The transmitting device 224 can be configured to transmit data over one or more networks via one or more network protocols. In some instances, the transmitting device 224 can be configured to transmit data to blockchain nodes 106, VASPs 108, payment networks 112, merchants 114, and other entities via one or more communication methods, local area networks, wireless area networks, cellular communication, Bluetooth, radio frequency, the Internet, etc. In some embodiments, the transmitting device 224 can be comprised of multiple devices, such as different transmitting devices for transmitting data over different networks, such as a first transmitting device for transmitting data over a local area network and a second transmitting device for transmitting data via the Internet. The transmitting device 224 can electronically transmit data signals that have data superimposed that can be parsed by a receiving computing device. In some instances, the transmitting device 224 can include one or more modules for superimposing, encoding, or otherwise formatting data into data signals suitable for transmission.

The transmitting device 224 can be configured to electronically transmit data signals to blockchain nodes 106 that can be superimposed or otherwise encoded with new blockchain data entries including industry classifications and unique identifiers, blockchain data requests, etc. The transmitting device 224 can also be configured to electronically transmit data signals to VASPs 108, which can be superimposed or otherwise encoded with industry classification notifications, requests for business data, transaction data requests, blockchain data requests, etc. The transmitting device 224 can also be configured to electronically transmit data signals to payment networks 112 that can be superimposed or otherwise encoded with transaction data requests. The transmitting device 224 can also be configured to electronically transmit data signals to merchants 114, which can be superimposed or otherwise encoded with data requests, notification messages, etc. The transmitting device 224 can also be configured to electronically transmit data signals to requesting entities, which can be superimposed or otherwise encoded with industry classification reports of one or more VASPs 108, etc.

### Process for Categorization of Virtual Asset Service Providers

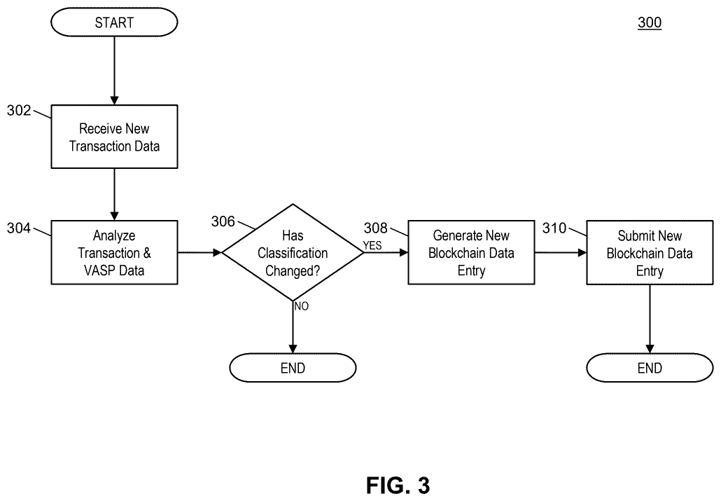

FIG. 3 illustrates a process 300 in the system 100 of FIG. 1 as performed by the processing server 102 for the categorization and industry classification of a virtual asset service provider (VASP) 108.

In step 302, the receiving device 202 of the processing server 102 can receive transaction data for new blockchain transactions involving the VASP 108. The querying module 214 of the processing server 102 can execute one or more queries to store the received transaction data in the transaction data 210 of the processing server 102 and/or in the account profile 208 associated with the VASP 108 in the account database 206 of the processing server 102. In step 304, the analysis module 222 of the processing server 102 can analyze the new transaction data along with all other available data to determine an industry classification for the VASP 108. The other available data can include all data in the account profile 208 associated with the VASP 108, transaction data for other blockchain transactions and traditional payment transactions involving the VASP 108, transaction data for blockchain transactions and traditional payment transactions involving other merchants 114, activity data for participants 110 associated with the VASP 108, and any other data available to the processing server 102.

In step 306, the processing server 102 can determine if the industry classification identified for the VASP 108 in step 304 has changed from the currency industry classification of the VASP 108 as stored in the account profile 208 for the VASP 108 and/or stored in the latest blockchain data entry in the blockchain with the unique identifier for the VASP 108. If the industry classification has not changed, then the process 300 completes and the processing server 102 waits until instructed to repeat the process 300 (e.g., upon request, after a predetermined period of time, etc.). If the industry classification has changed, then, in step 308, the generation module 216 of the processing server 102 generates a new blockchain data entry that includes the new industry classification and the unique identifier for the VASP 108 that is stored in the account profile 208 associated with the VASP 108. In some cases, the querying module 214 of the processing server 102 also executes a query on the account database 206 of the processing server 102 to update the industry classification in the account profile 208 associated with the VASP 108. In step 310, the transmitting device 224 of the processing server 102 electronically transmits the generated blockchain data entry to a blockchain node 106 in the blockchain network 104 to add the new blockchain data entry to the blockchain using traditional methods and systems.

### Exemplary Method for Categorization of Virtual Asset Service Providers

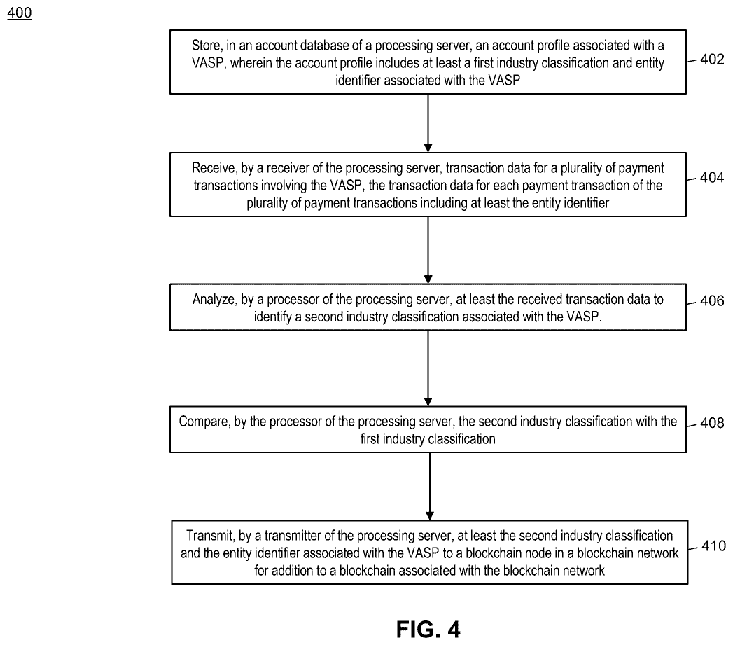

FIG. 4 illustrates a method 400 for the categorization of virtual asset service providers (VASPs) via transaction analysis and blockchain.

In step 402, an account profile (e.g., account profile 208) associated with a VASP (e.g., VASP 108) can be stored in an account database (e.g., account database 206) of a processing server (e.g., processing server 102), where the account profile can include at least a first industry classification and entity identifier associated with the VASP. In step 404, transaction data for a plurality of payment transactions involving the VASP can be received by a receiver (e.g., receiving device 202) of the processing server, the transaction data for each payment transaction of the plurality of payment transactions including at least the entity identifier.

In step 406, at least the received transaction data can be analyzed by a processor (e.g., analysis module 222) of the processing server to identify a second industry classification associated with the VASP. In step 408, second industry classification can be compared to the first industry classification by a processor (e.g., analysis module 222) of the processing server to determine if the first industry classification and the second industry classification match.

In step 410, in response to the second industry classification not matching the first industry classification, at least the second industry classification and the entity identifier associated with the VASP can be transmitted by a transmitter (e.g., transmitting device 224) of the processing server to a blockchain node (e.g., blockchain node 106) in a blockchain network (e.g., blockchain network 104) for addition to a blockchain associated with the blockchain network.

In one embodiment, the method 400 can also include storing, in a transaction database (e.g., transaction data 210) of the processing server, transaction information for a plurality of past transactions involving one or more alternative entities, analyzing the received transaction data can further include analyzing the received transaction data with the stored transaction information to identify the second industry classification. In some embodiments, the account profile can further include transaction information for a plurality of past payment transactions involving the VASP, and analyzing the received transaction data can further include analyzing the received transaction data with the transaction information to identify the second industry classification. In one embodiment, the plurality of payment transactions can include one or more transactions funded via cryptographic currency and/or one or more transactions funded via fiat currency.

In some embodiments, the account profile can further include at least one of user activity, business practices, and entity data associated with the VASP, and analyzing the received transaction data can further include analyzing the received transaction data with one or more of the at least one of user activity, business practices, and entity data associated with the VASP to identify the second industry classification. In one embodiment, the first industry classification can be a first merchant category code, and the second industry classification can be a second merchant category code. In some embodiments, the blockchain can be a public blockchain. In one embodiment, the method 400 can further include digitally signing, by the processor of the processing server, the second industry classification using a private key of a cryptographic key pair, wherein the second industry classification transmitted to the blockchain node can be the digitally signed second industry classification.

In some embodiments, a verification request of a current industry classification of a VASP can be received by a receiver (e.g., receiving device 202) of the processing server from a requesting entity. The verification request includes at least an entity identifier associated with a VASP. A processor (e.g., the querying module 216) of the processing server can execute a query on the blockchain network. The query can include the entity identifier included in the verification request. Blockchain data including the entity identifier included in the verification request can be received by a receiver (e.g., receiving device 202) of the processing server. The current industry classification included in the received blockchain data can be identified by a processor (e.g., the analysis module 222) of the processing server where the current industry classification can be the first industry classification or the second industry classification. An industry classification report including the current industry classification can be generated by a processor (e.g., the generation module 218) of the processing server and the industry classification report can be transmitted by a transmitter (e.g., the transmitting device 224) to the requesting entity.

### Computer System Architecture

FIG. 5 illustrates a computer system 500 in which embodiments of the present disclosure, or portions thereof, can be implemented as computer-readable code. For example, the processing server 102, blockchain nodes 106, virtual asset service provider 108, participants 110, and merchants 114 can be implemented in the computer system 500 using hardware, non-transitory computer readable media having instructions stored thereon, or a combination thereof and can be implemented in one or more computer systems or other processing systems. Hardware can embody modules and components used to implement the processes and methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the processes and methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for categorization of virtual asset service providers via transaction analysis and blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for categorization of virtual asset service providers (VASPs) via transaction analysis and blockchain, comprising:
storing, in an account database of a processing server, an account profile associated with a VASP, wherein the account profile includes at least a first industry classification and entity identifier associated with the VASP;
receiving, by a receiver of the processing server, transaction data for a plurality of payment transactions involving the VASP, the transaction data for each payment transaction of the plurality of payment transactions including at least the entity identifier;
analyzing, by a processor of the processing server, at least the received transaction data to identify a second industry classification associated with the VASP;
comparing, by the processor of the processing server, the second industry classification with the first industry classification; and
in response to the second industry classification not matching the first industry classification, transmitting, by a transmitter of the processing server, at least the second industry classification and the entity identifier associated with the VASP to a blockchain node in a blockchain network for addition to a blockchain associated with the blockchain network.

2. The method of claim 1, further comprising:
storing, in a transaction database of the processing server, transaction information for a plurality of past transactions involving one or more alternative entities, wherein
analyzing the received transaction data further includes analyzing the received transaction data with the stored transaction information to identify the second industry classification.

3. The method of claim 1, wherein
the account profile further includes transaction information for a plurality of past payment transactions involving the VASP, and
analyzing the received transaction data further includes analyzing the received transaction data with the transaction information to identify the second industry classification.

4. The method of claim 1, wherein the plurality of payment transactions includes one or more transactions funded via cryptographic currency and/or one or more transactions funded via fiat currency.

5. The method of claim 1, wherein
the account profile further includes at least one of user activity, business practices, and entity data associated with the VASP, and
analyzing the received transaction data further includes analyzing the received transaction data with one or more of the at least one of user activity, business practices, and entity data associated with the VASP to identify the second industry classification.

6. The method of claim 1, wherein
the first industry classification is a first merchant category code, and
the second industry classification is a second merchant category code.

7. The method of claim 1, wherein the blockchain is a public blockchain.

8. The method of claim 1, further comprising:
digitally signing, by the processor of the processing server, the second industry classification using a private key of a cryptographic key pair, wherein
the second industry classification transmitted to the blockchain node is the digitally signed second industry classification.

9. The method of claim 1, further comprising:
receiving, by the receiver of the processing server from a requesting entity, a verification request of a current industry classification of a VASP, the verification request including at least an entity identifier;
executing, by the processor of the processing server, a query on the blockchain network, the query including the entity identifier included in the verification request;
receiving, by the receiving device of the processing server from the blockchain node in the blockchain network, blockchain data, the blockchain data including the entity identifier included in the verification request;
identifying, by the processor of the processing server, the current industry classification included in the received blockchain data, the current industry classification being the first industry classification or the second industry classification;
generating, by the processor of the processing server, an industry classification report, the industry classification report including the current industry classification; and
transmitting, by the transmitter of the processing server, the report to the requesting entity.

10. A system for categorization of virtual asset service providers (VASPs) via transaction analysis and blockchain, comprising:
a blockchain network;
a blockchain node in the blockchain network; and
a processing server, the processing server including
an account database storing an account profile associated with a VASP, wherein the account profile includes at least a first industry classification and entity identifier associated with the VASP,
a receiver receiving transaction data for a plurality of payment transactions involving the VASP, the transaction data for each payment transaction of the plurality of payment transactions including at least the entity identifier,
a processor analyzing at least the received transaction data to identify a second industry classification associated with the VASP,
a processor comparing the second industry classification with the first industry classification, and
in response to the second industry classification not matching the first industry classification, a transmitter transmitting at least the second industry classification and the entity identifier associated with the VASP to the blockchain node for addition to a blockchain associated with the blockchain network.

11. The system of claim 10, wherein
the processing server further includes transaction database storing transaction information for a plurality of past transactions involving one or more alternative entities, and
analyzing the received transaction data further includes analyzing the received transaction data with the stored transaction information to identify the second industry classification.

12. The system of claim 10, wherein
the account profile further includes transaction information for a plurality of past payment transactions involving the VASP, and
analyzing the received transaction data further includes analyzing the received transaction data with the transaction information to identify the second industry classification.

13. The system of claim 10, wherein the plurality of payment transactions includes one or more transactions funded via cryptographic currency and/or one or more transactions funded via fiat currency.

14. The system of claim 10, wherein
the account profile further includes at least one of user activity, business practices, and entity data associated with the VASP, and
analyzing the received transaction data further includes analyzing the received transaction data with one or more of the at least one of user activity, business practices, and entity data associated with the VASP to identify the second industry classification.

15. The system of claim 10, wherein
the first industry classification is a first merchant category code, and
the second industry classification is a second merchant category code.

16. The system of claim 10, wherein the blockchain is a public blockchain.

17. The system of claim 10, wherein
the processor of the processing server digitally signs the second industry classification using a private key of a cryptographic key pair, and
the second industry classification transmitted to the blockchain node is the digitally signed second industry classification.

18. The system of claim 10, further comprising:
the receiver receiving, from a requesting entity, a verification request of a current industry classification of a VASP, the verification request including at least an entity identifier;
the processor of the processing server executes a query on the blockchain network, the query including the entity identifier included in the verification request;
the receiver receiving, from the blockchain node in the blockchain network, blockchain data, the blockchain data including the entity identifier included in the verification request;
the processor of the processing server identifies the current industry classification included in the received blockchain data, the current industry classification being the first industry classification or the second industry classification;
the processor of the processing server generates an industry classification report, the industry classification report including the current industry classification; and
the transmitter transmitting the report to the requesting entity.
